(19) United States
(12) Patent Application Publication
(10) Pub. No.: US 2025/0095351 A1
(43) Pub. Date: Mar. 20, 2025

(54) ONE-SHOT IMITATION METHOD AND LEARNING METHOD IN A NON-STATIONARY ENVIRONMENT THROUGH MULTIMODAL-SKILL, AND APPARATUS AND RECORDING MEDIUM THEREOF

(71) Applicant: Research & Business Foundation Sungkyunkwan University, Suwon-si (KR)

(72) Inventors: Sangwoo SHIN, Suwon-si (KR); Daehee LEE, Goyang-si (KR); Minjong YOO, Suwon-si (KR); Wookyoung KIM, Suwon-si (KR); Honguk WOO, Suwon-si (KR)

(73) Assignee: Research & Business Foundation Sungkyunkwan University, Suwon-si (KR)

(21) Appl. No.: 18/813,639

(22) Filed: Aug. 23, 2024

(30) Foreign Application Priority Data
Sep. 15, 2023 (KR) 10-2023-0123090

(51) Int. Cl. G06V 10/82; G06V 20/40

(52) U.S. Cl. CPC G06V 10/82; G06V 20/40

(57) ABSTRACT

An embodiment of the present disclosure relates to a learning method of a one-shot imitation method based on an artificial neural network model that adaptively one-shot imitates a video demonstration of an expert, wherein the method includes: a first stage of learning to infer a semantic skill sequence from a given expert demonstration; a second stage of learning to infer dynamics based on state-action pairs, which are the minimum units that form an action trajectory of the expert in the given expert demonstration; and a third stage of learning to create an action sequence by combining the inferred semantic skill sequence and dynamics based on given environmental data.

### CROSS REFERENCE TO RELATED APPLICATION

This application claims priority from Republic of Korea Patent Application No. 10-2023-0123090, filed on 15 Sep. 2023, which is hereby incorporated by reference in its entirety.

### BACKGROUND

### Field

The present disclosure relates to a one-shot imitation method, which learns a model utilizing a pre-trained vision-language model and adaptively performs a single one-shot imitation so that an agent may execute correctly in various domains.

### Related Art

One-shot imitation makes it possible to learn a new task through a single expert demonstration. Simultaneously, although it is highly practical to imitate expert demonstrations in an environment (or domain) different from the one in which an agent (for example, a robot) was trained, it is difficult to one-shot imitate a task in a non-stationary setting with high domain diversity.

As a one-shot imitation learning method, which learns a task through a single expert demonstration through video or verbal instructions, first, there is a BC-Z technique, which increases the similarity between the video and its verbal instructions to utilize the semantic information inherent in the demonstration; and second, there is a Decision Transformer-based method that conditionally learns from expert demonstrations to utilize the high sequential prediction ability and attention of a transformer.

However, the performance of both methods deteriorates when a model imitates expert demonstrations in a new domain rather than the environment in which the model was trained.

### SUMMARY

The present disclosure has been devised to obviate the above limitation. An aspect of the present disclosure is designed to enable efficient and stable imitation without performance degradation when one-shot imitating an expert in a new non-stationary environment that an agent has not seen in a learning process.

An embodiment relates to a learning method of a one-shot imitation method based on an artificial neural network model that adaptively one-shot imitates a video demonstration of an expert, wherein the method includes: a first stage of learning to infer a semantic skill sequence from a given expert demonstration; a second stage of learning to infer dynamics based on state-action pairs, which are the minimum units that form an action trajectory of the expert in the given expert demonstration; and a third stage of learning to create an action sequence by reassembling the inferred semantic skill and dynamics based on given environmental data.

The one-shot imitation method of an embodiment relates to a one-shot imitation method based on an artificial neural network model that adaptively one-shot imitates a video demonstration of an expert, wherein the method includes: a first stage of inferring a semantic skill sequence from a given expert demonstration; a second stage of operating an agent to generate state-action pairs in time series and inferring the dynamics of a current state based thereon; and a third stage of performing an action appropriate for a new domain by combining the inferred semantic skill sequence and inferred dynamics based on currently acquired environmental data and recombining the inferred semantic skills.

Other embodiments of the present disclosure describe a computing device that implements the aforementioned method and a recording medium recording the same.

According to an embodiment of the present disclosure, the task is addressed only through a single expert demonstration, and furthermore, the issue of performance degradation that occurs when an agent is executed in a new non-stationary environment that was not seen in the learning process is addressed. Accordingly, the issues of real-world imitation learning models that need to be executed in various environments can be addressed data-efficiently.

### BRIEF DESCRIPTION OF THE DRAWINGS

FIG. 1 is a diagram conceptually explaining an embodiment of the present disclosure.

FIG. 2 is a diagram illustrating the configuration of an artificial neural network model that implements one-shot imitation according to an embodiment of the present disclosure.

FIGS. 3 and 4 are diagrams illustrating a method of learning and executing one-shot imitation according to an embodiment of the present disclosure, respectively.

FIG. 5 is a diagram illustrating a computing device executing the method for learning and executing one-shot imitation according to an embodiment of the present disclosure.

### DESCRIPTION OF EXEMPLARY EMBODIMENTS

Hereinafter, embodiments of the present disclosure will be described in detail with reference to the drawings. In the following description and accompanying drawings, detailed descriptions of well-known functions or elements may be omitted in order not to obscure the gist of the present disclosure. Throughout the specification, when a part is referred to as “including” a certain component, it means that it may further include other components without excluding other components unless specifically described otherwise.

In addition, terms such as “first” and “second” may be used to describe various components, but the components are not restricted by the terms. The terms are used only to distinguish one component from another component. For example, a first component may be named a second component without departing from the scope of the right of the present disclosure. Likewise, a second component may be named a first component.

The terms used in the present specification are merely used to describe specific embodiments and are not intended to limit the present disclosure. A singular expression includes a plural expression, unless the context clearly states otherwise. In the present specification, it should be understood that the terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Unless specifically defined otherwise, all terms used herein, including technical or scientific terms, have the same meaning as commonly understood by those of ordinary skill in the art to which the present disclosure belongs. Terms such as those defined in commonly used dictionaries are to be interpreted as having a meaning consistent with the meaning in the context of the related art and are not to be construed as ideal or overly formal in meaning unless expressly defined in the present application.

An embodiment of the present disclosure utilizes a trained vision-language model to infer the sequence of semantic skills inherent in a video from a single expert video demonstration, and to find hidden parameters inherent in an environment from state-action pairs of an expert.

Herein, the vision-language model includes a vision encoder and a language encoder, and is an artificial neural network model in which the vision encoder vectorizes and maps the input video into an embedding space, and the language encoder maps language instructions given in text form to the same embedding space and predicts the similarity between the two.

In addition, the semantic skills are the minimum unit of an expert's action demonstrated in an expert demonstration, and is also the minimum unit of action expressed linguistically in the trained vision-language model.

In addition, the state-action pair is the minimum unit of the overall trajectory moved when a task is performed in an expert demonstration, and is also the log of when an agent performs the task. Accordingly, the task may also be defined as a sequence of the state-action pairs.

In an embodiment of the present disclosure, prompt-based learning is performed so that the trained vision-language model may be fine-tuned in a data-efficient manner. This prompt-based learning is trained through contrastive learning so that the embeddings of the video itself resemble the semantic information inherent in the video. Thus, it is possible to effectively separate and infer only information (semantic skills) about tasks to be performed that are unrelated to the environment.

In addition, an embodiment of the present disclosure uses contrastive learning to infer parameters for an environment from the state-action pairs. This learning ensures that the state-action pairs executed in the same environment are embedded in the same place, and the state-action pairs executed in different environments are embedded far apart from each other.

Learning based on such prompts infers, from expert demonstrations, a sequence of skills that are the detailed components of a task to be performed (for example, open a door, close a drawer), while learning environmental parameters based on the state-action pairs infers information about the current environment (for example, the strength of the wind currently blowing in the environment).

Thus, an embodiment of the present disclosure may perform stable one-shot imitation learning even in a non-stationary environment that the agent newly encounters.

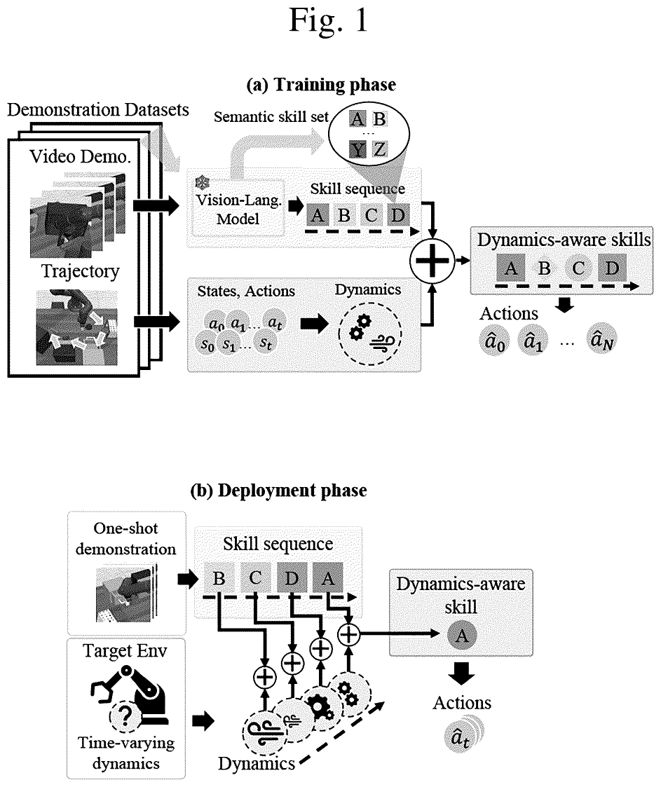

FIG. 1 is a diagram conceptually explaining an embodiment of the present disclosure.

In FIG. 1, an embodiment of the present disclosure includes a training phase for single one-shot imitation and a deployment phase for driving an agent by reconfiguring an expert demonstration according to what has been trained.

The one-shot imitation proposed so far requires an expert demonstration for each environment. In other words, even when imitating a single task such as opening a door, if the environment is changed, the expert demonstration has to be imitated again in a different environment. For example, in order to imitate the same task of opening a door in a windy environment and a non-windy environment, the expert demonstration in the windy environment and the expert demonstration in the non-windy environment need to be imitated separately to match the respective environments and execute the task. When an agent is placed in an environment that is different from the expert demonstration that it imitates, the agent cannot imitate the task even when it is the same task.

Unlike the above, the one-shot imitation method proposed in an embodiment of the present disclosure relates to a method that may adaptively imitate an expert demonstration in all environments only with a single expert demonstration.

To this end, in an embodiment of the present disclosure, the expert demonstration is disassembly trained into semantic skills, which are the minimum unit of performing a task, which are movement elements, and dynamics, which are environmental elements.

In an execution stage, given a video demonstration of a single expert (or video demo) of a task, semantic skills are inferred by segmenting the expert demonstration, and dynamics are inferred from the sequence of state-action pairs generated by operating the trained agent. Thereafter, the agent is executed by combining the semantic skill and dynamics inferred based on environmental data to infer the action sequence according to environmental parameters.

In the learning process of FIG. 1, in an embodiment of the present disclosure, an expert demonstration video (video demo) and a state-action pair according to a trajectory within the expert demonstration video are given as training data sets, respectively. Herein, the trajectory within the video may be described as a sequence of state-action pairs as a log of how the agent performed the task in the expert demonstration.

The artificial neural network model that receives the training data set is trained to predict semantic skills based on expert demonstration videos, and is also trained to predict dynamics based on sequences of state-action pairs. Herein, since the state-action pair describes the state change of the agent recorded in a special physical environment, environmental parameters may be inferred through the change in the state-action pair and the next state-action pair in the state-action pair sequence.

In addition, during a learning process, the skill sequence and dynamics are combined to infer an action sequence, which refers to the actions of an agent that reflect the environmental parameters.

In an execution process, in a given expert demonstration, the artificial neural network model infers the skill sequence according to what has been trained, and also infers the dynamics as trained based on the state-action pair sequence that occurs as the agent moves, thereby combining dynamics and skills based on the currently input environmental data to infer an action sequence appropriate for a new domain (a domain that is environmentally different from the expert demonstration).

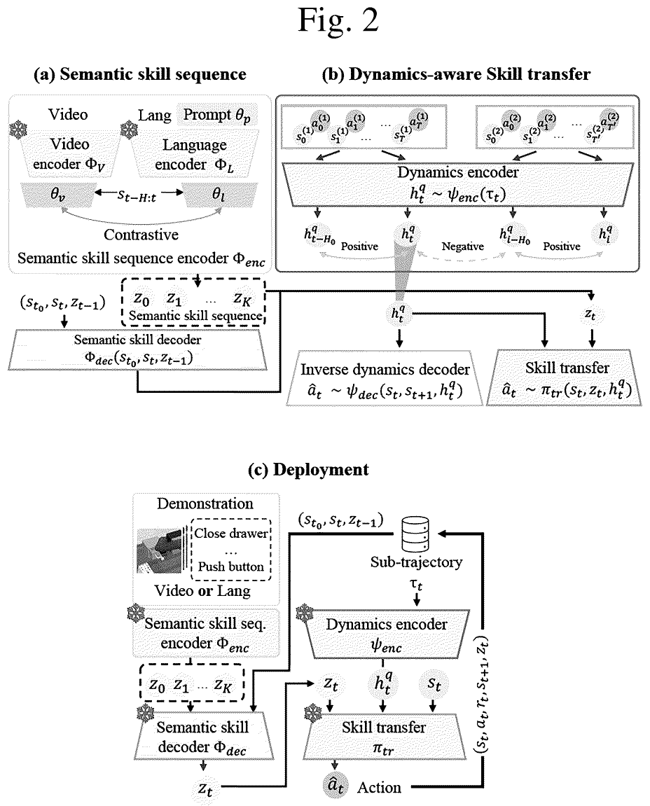

FIG. 2 is a diagram illustrating the configuration of an artificial neural network model that implements one-shot imitation according to an embodiment of the present disclosure.

In FIG. 2, the artificial neural network model includes a semantic skill module (a) and a skill transfer module (b).

The semantic skill module (a) includes a semantic skill encoder (Φ_{enc}) and a semantic skill decoder (Φ_{dec}), and the semantic skill encoder (Φ_{enc}) is trained offline using a pre-trained CLIP vision-language model. Herein, the semantic skill encoder converts the video demonstration of an expert into a semantic skill sequence and learns by contrast, and the semantic skill decoder (Φ_{dec}) learns a method of inferring the optimal skill from the semantic skill sequence depending on a state.

The language prompt (θₚ) is used only for sub-level instruction cases, and the additional encoder (θᵥ, θₜ) is used only for episode-level instruction cases.

The skill transfer module (b) includes skill transfer (πₜᵣ) and a dynamics encoder (ψ_{enc}), and the skill transfer and dynamics encoder are trained offline. Herein, the skill transfer (πₜᵣ) learns a method of inferring an action sequence optimized for the operation (execution) of an agent from the given semantic skill sequence and the inferred dynamics, and the dynamics encoder (ψ_{enc}) learns a method of inferring dynamics in sub-trajectories.

In the artificial neural network model configured as such, for a given expert demonstration, the semantic skill encoder (Φ_{enc}) infers the semantic skill sequence as trained in the given expert demonstration, the semantic skill decoder (Φ_{dec}) infers the semantic skill to be currently executed, and the dynamics encoder (ψ_{enc}) infers the current dynamics in a non-stationary execution environment. Then, the skill transfer (tr) creates an optimized action through the current semantic skill and dynamics.

Hereinafter, each configuration that configures the artificial neural network model will be described in more detail as follows.

Semantic Skill Encoder (Φ_{enc})

The semantic skill encoder maps an expert demonstration ( ) to a sequence of semantic skills by segmenting the expert demonstration into environment-independent behavior patterns (dynamics-invariant behavior) that are action sequences. Each behavioral pattern corresponds to a minimal sequence of expert demonstrations and may be described as language instructions in an environment. The behavior patterns of an expert related to these verbal instructions may be described as semantic skills, and the related verbal instructions are used to represent the expert behavior on the semantic embedding space of the vision-language model.

To implement the semantic skill encoder, an embodiment of the present disclosure uses a pre-trained CLIP vision-language model and sample effective prompt learning techniques. Specifically, an embodiment of the present disclosure utilizes a dataset) ( [symbol] ={τ₁, τ₂, . . . , τ_{N}}) of expert trajectories, wherein each trajectory (τ={(s1, v1, l1, a1), . . . (sT, vT, lT, aT)} is expressed as a length T. The elements of the trajectory are configured of state s, visual observation v, verbal instruction l, and action a, and thus include verbal instruction data. Each language instruction is an element of an instruction set L.

In addition, an embodiment of the present disclosure considers two other cases of language instructions displayed in trajectories. One is a sub-task level instruction, for example, “push lever” indicated at the transition of a single subtask (the process of moving from one state-action pair to the next state-action pair), and the other is an episode level instruction, for example, “Push the lever, open the door, and close the box,” which appears in every transition in an episode.

In the case of sub-task level instructions, an embodiment of the present disclosure assumes that language instructions exist only for a small subset ( [symbol] ₀ of [symbol] ), and the video encoder (Φ_{V}) and language encoder (Φ_{L}) of the vision-language model may be expressed as Equation 1 below.

$${Φ}_{V} : {υ}_{t : t + H} ↦ {z}_{υ} , {Φ}_{L} : {l}_{t} ↦ {z}_{t} , \qquad [ Equation 1 ]$$

These two encoders (Φ_{V}, Φ_{L}) map the expert video demonstration (v_{t:t}+H) and language instructions (lₜ) of a time step t into the same embedding space. To implement the semantic skill encoder (Φ_{enc}) based on the two encoders (Φ_{V}, Φ_{L}) using a small number of samples, an embodiment of the present disclosure uses language prompts. When v_{t:t}+H or lₜ is given as an input d, the semantic skill encoder learns a method of converting each input into a sequence of semantic skills based on Equation 2 below.

$${Φ}_{enc} ( d ) = \{ \begin{matrix}{argmax}_{𝓏 ∈ {𝓏}_{L}} \{ sim ( 𝓏 , {Φ}_{V} ( {v}_{t : t + H} ) ) \} , & d = {d}_{v} \\ \{ {Φ}_{L} ( {l}_{t} ; {θ}_{p} ) \} , & d = {d}_{t}\end{matrix} \qquad [ Equation 2 ]$$

In Equation 2 above, dᵥ=(v_{t:t+H}:0≤t≤T′) dₗ=(lₜ:0≤t≤N), z_{L}=Φ_{L}(L; θₚ) and Lis a language instruction set.

The language prompt) is trained through contrastive learning on positive pairs (v_{t:t}+H·lₜ) of [symbol] ₀ values, and a contrastive loss ( [symbol] _{CON}(θₚ)) is defined as Equation 3 below.

$${CON}_{} ( {θ}_{p} ) = - log ( \frac{sim ( {Φ}_{V} ( {v}_{t : t + H} ) , {Φ}_{L} ( {l}_{t} ; {θ}_{p} ) )}{{\sum }_{{l}_{i} \neq l ∈ L} sim ( {Φ}_{V} ( {v}_{t : t + H} ) , {Φ}_{L} ( {l}_{t} ; {θ}_{p} ) )} ) \qquad [ Equation 3 ]$$

In addition, the latent vector (z, z′)d is calculated by Equation 4 below.

$$sim ( 𝓏 , {𝓏}^{′} ) = \frac{1}{α} exp ( \frac{〈 𝓏 , {𝓏}^{′} 〉}{‖ 𝓏 ‖ ‖ {𝓏}^{′} ‖} ) \qquad [ Equation 4 ]$$

In Equation 4, α is the temperature coefficient.

As such, for the sub-task level instruction case, the semantic skill encoder may be set based on pre-trained visual and language encoders (Φ_{V}, Φ_{L}) through prompt-based contrastive learning on a small set of video and text search samples.

In the case of episode level instructions, all transitions of the episode in [symbol] are related only to a single instruction without detailed sub-task level instructions. Accordingly, an embodiment of the present disclosure adopts unsupervised skill learning published (Garg et al., 2022) along with contrastive learning for video features. In other words, Φ_{enc}(d) learns to convert video demos (d=v₀:T′) or language instructions (d=l) into semantic skill sequences. When z_{L}=θₗ(Φ_{L}(L), s_{t-H:t}), it is equivalent to Equation 5 below.

$$\{ \begin{matrix}{\{ argmax}_{𝓏 ∈ {𝓏}_{L}} \{ sim ( 𝓏 , {θ}_{V} ( {Φ}_{V} ( {v}_{0 : {T}^{′}} ) , {s}_{t - H : t} ) \} \} , & d = {v}_{0 : {T}^{′}} \\ \{ {θ}_{l} \{ {Φ}_{L} ( l ) , {s}_{t - H : t} ) \} , & d = l\end{matrix} \qquad [ Equation 5 ]$$

Similar to the skill predictor used in (Garg et al., 2022), two additional encoders, θᵥ and θₗ, are trained as shown in Equation 5 below.

$${θ}_{v} : ( {Φ}_{V} ( {v}_{0 : {T}^{′}} ) , {s}_{t - H : t} ) ↦ {𝓏}_{v} \qquad [ Equation 6 ]$$

$${θ}_{l} : ( {Φ}_{L} ( l ) , {s}_{t - H : t} ) ↦ {𝓏}_{l}$$

The encoder (θᵥ) is contrastively trained on the positive pair (v_{0:T′}, l), where the contrastive loss ( [symbol] _{CON}(θₚ) is zₗ=θₗ(Φ_{L}(l), s_{t-H:t}), and may be rewritten as Equation 7 below when z_{L}=θₗ(Φ_{L}(L), s_{t-H:t})

$${CON}_{} ( {θ}_{v} ) = - log ( \frac{sim ( {θ}_{v} ( {Φ}_{V} ( {v}_{0 : {T}^{′}} ) , {s}_{t - H : t} ) , {𝓏}_{l} )}{{\sum }_{{𝓏}_{i} \neq 𝓏 ∈ {𝓏}_{L}} sim ( {θ}_{v} ( {Φ}_{V} ( {v}_{0 : {T}^{′}} ) , {s}_{t - H : t} ) , 𝓏 )} ) \qquad [ Equation 7 ]$$

The encoder (θₜ) is trained through action replication that maximizes mutual information between actions and semantic skills, and the loss is as shown in Equation 8 below for an action reconstruction model (f:(sₜ,zₗ)→aₜ).

$${BC}_{} ( {θ}_{l} , f ) ) = [ ‖ {a}_{t} - f ( {s}_{t} , {𝓏}_{l} ) ‖ ] \qquad [ Equation 8 ]$$

Semantic Skill Decoder (Φ_{dec})

In a sequence of given semantic skills, the semantic skill decoder infers one semantic skill for the current state.

This semantic skill decoder is implemented as a binary model that determines whether the current semantic skill has ended. Expressing this mathematically, it is the same as shown in Equation 9 below.

$${Φ}_{dec} : ( {s}_{{t}_{o}} , {s}_{t} , {𝓏}_{t} ) ↦ \{ 0 , 1 \} \qquad [ Equation 9 ]$$

For the currently executed semantic skill (zt), sto: initial state, current state: st, and Φ_{dec} is trained in [symbol] using BCE (binary cross entropy) as shown in Equation 10 below.

$${BCE}_{} ( {Φ}_{dec} ) = BCE ( {{𝓏}_{i} \neq {𝓏}_{i + 1}}_{} , {Φ}_{dec} ( {s}_{{t}_{o}} , {s}_{t} , {𝓏}_{t} ) ) \qquad [ Equation 10 ]$$

$$where {𝓏}_{t} = {Φ}_{v} ( {v}_{t : t + H} ) .$$

As exemplified in FIG. 2(A), the semantic skill encoder (Φ_{enc}) is trained through contrastive learning to extract semantic skills from a video. The semantic skill decoder (Φ_{dec}), which is a binary classifier, is conditioned according to a skill sequence and is trained to predict the appropriate semantic skill at the current stage.

### Skill Transfer (πₜᵣ)

For a given semantic skill encoder (Φ_{enc}), the skill transfer (πₜᵣ) converts the semantic skill (zₜ=Φ_{enc}(v_{t:t+H})) into an action sequence optimized for the environment in which an agent is to be executed.

The skill transfer (πₜᵣ) is described as Equation 11 below.

$${π}_{tr} : ( {s}_{t} , {𝓏}_{t} , {h}_{t}^{q} ) ↦ {a}_{t} \qquad [ Equation 11 ]$$

Herein, sₜ is the current state, Et is the semantic skill, and hₜ^{q}=ψ_{enc}(τₜ) is the dynamics embedding.

For the Ho length sub-orbit (τ_{L}=(sₜ−Hₒ, aₜ−Hₒ, . . . , sₜ₋₁, aₜ₋₁)), as shown in Equation 11, the dynamics encoder (ψ_{enc}) considers the same as an input and maps the same to a quantized vector (hₜ^{q}), and ψ_{enc}^{c} maps τₜ to a continuous latent vector.

$${ψ}_{enc} = q ◦ {ψ}_{enc}^{c} : {τ}_{t} ↦ {h}_{t}^{q} \qquad [ Equation 12 ]$$

In an embodiment of the present disclosure, a vector quantization operator q is used to avoid posterior collapse. The output of q is the closest vector among the learning parameters and is called a code book (h^{q}∈{h^{q1}, . . . , h^{qM}}).

Next, the embedding (hₜ^{q}) of the quantized dynamics is obtained as shown in Equation 13 below.

$${h}_{t}^{q} = q ( {ψ}_{enc}^{c} ( {τ}_{t} ) ) = {argmin}_{j ∈ \{ 1 , ⋯ , M \}} \{ ‖ {ψ}_{enc}^{c} ( {τ}_{t} ) - {h}^{{q}_{j}} ‖ \} \qquad [ Equation 13 ]$$

For the semantic skill (zₜ=Φ_{enc}(v_{t:t+H})) and dynamics embedding (hₜ^{q}=ψ_{enc}(τₜ)), the skill transfer and dynamics encoder are trained together in a form that minimizes behavior cloning (BC) as shown in Equation 14.

$${{s}_{T} , {a}_{T} \sim 𝒟}_{} [ {‖ {a}_{t} - {τ}_{tr} ( {s}_{t} , {𝓏}_{t} , {ψ}_{enc} ( {τ}_{t} ) ) ‖}^{2} ] \qquad [ Equation 14 ]$$

In addition, contrastive learning on sub-trajectories of various dynamics is also used to separate task-irrelevant dynamics from the sub-trajectories. Specifically, it is assumed that H₀-length sub-trajectories ({τₜ_{ᵢ}}1≤i≤N) include positive samples, (τₜ_{ⱼ}, τₜ_{ₖ}) from the same trajectory starting at different time steps. Then, ψ_{enc} is trained on positive and negative pairs, and the contrastive loss ( [symbol] _{CON}(ψ_{enc})) is the same as shown in Equation 15.

$${CON}_{} ( {ψ}_{enc} ) = - log ( \frac{sim ( {ψ}_{enc} ( {τ}_{{t}_{j}} ) , {ψ}_{enc} ( {τ}_{{t}_{k}} )}{{\sum }_{i \neq {i}^{′}} sim ( {ψ}_{enc} ( {τ}_{{t}_{i}} ) , {ψ}_{enc} ( {τ}_{{t}_{{i}^{′}}} )} ) \qquad [ Equation 15 ]$$

To maximize the mutual information between the inferred embeddings and dynamics, reconstruction-based feature extraction was adopted using an inverse dynamics decoder (ψ_{dec}:(sₜ, sₜ₊₁, hₜ^{q})→aₜ). Herein, the action reconstruction loss is the same as shown in Equation 16.

$${REC}_{} ( {ψ}_{enc} , {ψ}_{dec} ) = {t - {H}_{o} \leq i < t}_{} [ {‖ {a}_{t} - {ψ}_{dec} ( {s}_{t} , {s}_{i + 1} , {ψ}_{enc} ( {τ}_{t} ) ) ‖}^{2} ] \qquad [ Equation 16 ]$$

The skill transfer (πₜᵣ), dynamics encoder (ψ_{enc}), and inverse dynamics decoder (ψ_{dec}) are trained together to minimize loss ( [symbol] _{BC}, [symbol] _{CON} and [symbol] _{REC}).

The learning procedure for the skill transfer is the same as Algorithm 1 below.

Algorithm 1 Learning to transfer skills

| | |
|---|---|
| 1: | Semantic skill sequence encoder Φ_{enc} |
| 2: | Dynamics encoder ψ_{enc}, Inverse dynamics decoder |
| | ψ_{dec} |
| 3: | Skill transfer module πₜᵣ, Dataset D |
| 4: | repeat |
| 5: | Sample a batch {(τₜ [symbol] , υₜ [symbol] _{:t} [symbol] + H)} [symbol] ~ D |
| 6: | {zₜ [symbol] } [symbol] = Φ_{enc}({υₜ [symbol] _{:t} [symbol] + H} [symbol] ) |
| 7: | l* Calculate loss with {(τₜ [symbol] , zₜ [symbol] )}*l |
| 8: | loss_{bc} ← L_{BC}(πₜᵣ, ψ_{enc}) using (16) |
| 9: | loss_{con} ← L_{CON}(ψ_{enc}) using (17) |
| 10: | loss_{rec} ← L_{REC}(ψ_{enc}, ψ_{dec}) using (18) |
| 11: | ψ_{enc} ← ψ_{enc} − ∇_{ψ}_{_{enc}}(loss_{bc} + loss_{con} + loss_{rec}) |
| 12: | ψ_{dec} ← ψ_{dec} − ∇_{ψ}_{_{dec}}loss_{rec} |
| 13: | πₜᵣ ← πₜᵣ − ∇_{π}_{ₜᵣ}loss_{bc} |
| 14: | until converge |

[symbol]

indicates data missing or illegible when filed

Hereinafter, the results of an experiment to evaluate an artificial intelligence model for one-shot imitation of the aforementioned configuration is described.

The experiment was conducted using a mujoco-based robot arm in a multi-stage Meta-world simulation environment to evaluate performance. In order to describe a non-stationary environment, when an agent performed an action aₜ, the action aₜ+wₜ was performed by adding a variable wₜ that changes with time (t) to aₜ. To compare the performance of one-shot imitation learning in the non-stationary environment, the imitation learning methodology of BC-Z, Decision Transformer (DT) and skill learning methodology of Skill prior RL (SPiRL) were used. In the experiment, the model trained by the method when semantic skills for each video frame were given was named S-OnIS, and the model trained by the method when only the description of the entire video was given was named U-OnIS.

### 1. One-Shot Imitation of Expert Video Demonstrations and Language Instructions

### [Table 1]

TABLE 1
One-shot initiation performance for video demonstration: for multi-
stage Meta-world tasks, the performance in task success rates by our
U-OnIS, S-OnIS and other baslines is measured against various test
conditions on K sequential objectives in a task (K = 1, 2, 4)
and dynamics change levels (stationary, low, medium, and high).

| K | Non-st. | VSPiRL | BC-Z | U-OnIS | S-OnIS |
|---|---|---|---|---|---|
| 1 | Stationary | 61.48% | 75.00% | 95.80% | 100% |
| | Low | 48.23% | 48.33% | 86.28% | 94.55% |
| | Medium | 45.22% | 44.29% | 84.09% | 94.34% |
| | High | 39.09% | 37.63% | 81.10% | 90.49% |
| 2 | Stationary | 61.75% | 71.08% | 67.50% | 100% |
| | Low | 41.66% | 42.85% | 75.75% | 85.66% |
| | Medium | 43.39% | 47.61% | 73.07% | 84.29% |
| | High | 30.33% | 22.09% | 66.00% | 81.62% |
| 4 | Stationary | 47.44% | 21.01% | 64.38% | 91.67% |
| | Low | 27.31% | 14.38% | 50.03% | 74.95% |
| | Medium | 20.82% | 12.79% | 49.22% | 74.89% |
| | High | 15.54% | 11.13% | 49.82% | 70.19% |

Table 1 shows the imitation learning performance when one expert video is given. This is an experiment to show that the method proposed in an embodiment of the present disclosure (S-OnIS, U-OnIS) improves learning performance compared to other comparison groups. It is understood that the method presented in an embodiment of the present disclosure improves performance by 38.25 to 54.64% compared to SPiRL, the strongest comparison group. Table 2 shows the imitation learning performance when language instructions are given, and shows similar performance to imitating video demonstrations.

### [Table 2]

TABLE 2
One-shot imitation performance for language instruction

| K | Non-st. | L-DT | L-SPiRL | BC-Z | U-OnIS | S-OnIS |
|---|---|---|---|---|---|---|
| 1 | Stationary | 92.66% | 100.0% | 100.0% | 87.70% | 100.0% |
| | Low | 62.49% | 54.29% | 96.61% | 90.40% | 95.00% |
| | Medium | 53.84% | 50.71% | 75.32% | 81.29% | 89.04% |
| | High | 20.19% | 47.75% | 68.91% | 82.19% | 88.50% |
| 2 | Stationary | 58.33% | 60.08% | 76.25% | 74.50% | 95.00% |
| | Low | 47.12% | 29.35% | 45.27% | 60.44% | 83.17% |
| | Medium | 33.17% | 34.34% | 35.00% | 69.24% | 78.50% |
| | High | 30.28% | 20.51% | 25.52% | 66.67% | 77.27% |
| 4 | Stationary | 37.73% | 43.16% | 40.30% | 67.71% | 87.50% |
| | Low | 22.11% | 22.83% | 20.23% | 59.64% | 76.60% |
| | Medium | 20.43% | 15.50% | 20.60% | 56.68% | 71.39% |
| | High | 8.90% | 16.39% | 11.13% | 54.82% | 66.92% |

### 2. Agent Execution in Non-Stationary Environment

As shown in Tables 1 and 2, the method presented in an embodiment of the present disclosure showed more robust performance in a non-stationary environment compared to other comparison groups. For example, in Table 2, the performance degradation in the non-stationary environment of the comparison group occurred by 19.72% to 57.02%, while the method presented in an embodiment of the present disclosure showed only a performance degradation of 9.49% to 18.13%.

Hereinafter, the learning method and one-shot imitation method of an embodiment related to the artificial intelligence model for one-shot imitation described above are described as follows.

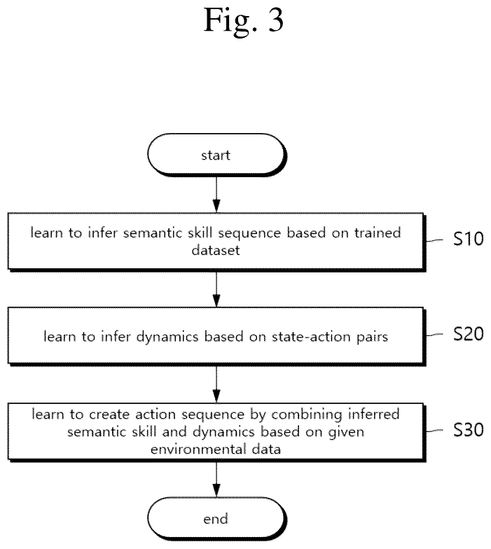

The learning method of an embodiment is as described in FIG. 3.

Referring to FIG. 3, an embodiment relates a learning method of a one-shot imitation method based on an artificial neural network model that adaptively one-shot imitates a video demonstration of an expert, wherein the method includes: a first stage of learning to infer a semantic skill sequence from a given expert demonstration (S10); a second stage of learning to infer dynamics based on state-action pairs, which are the minimum units that form an action trajectory of the expert in the given expert demonstration (S20); and a third stage of learning to create an action sequence by reassembling the inferred semantic skill and dynamics based on given environmental data (S30).

In this embodiment, the first stage (S10) and the second stage (S20) correspond to the stage of training the semantic skill encoder described above. In the first stage, the artificial neural network model maps the expert demonstrations to a sequence of semantic skills by segmenting the expert demonstrations into environment-independent behavior patterns (dynamics-invariant behavior), which are action sequences. The semantic skill encoder is trained through prompted learning techniques and contrastive learning based on the pre-trained CLIP vision-language model.

The third stage (S30) corresponds to the step of training the skill transfer.

The skill transfer learns a method of inferring an action sequence optimized for execution from given semantic skills and inferred dynamics.

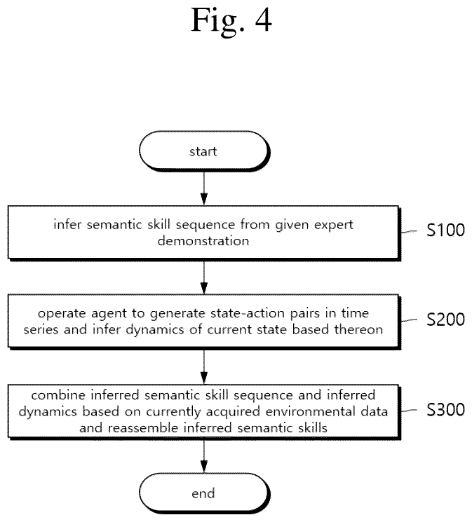

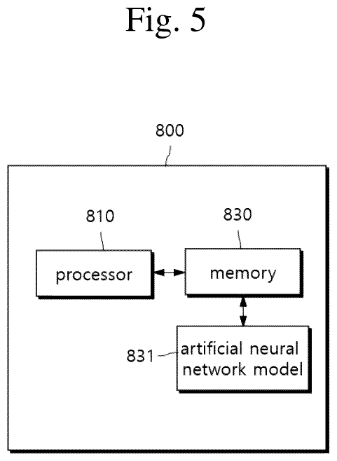

The one-shot imitation method of an embodiment is as described in FIG. 4.

Referring to FIG. 4, the one-shot imitation method of an embodiment includes: a first stage of inferring a semantic skill sequence from a given expert demonstration (S100); a second stage of operating an agent to generate state-action pairs in time series and inferring the dynamics of a current state based thereon (S200); and a third stage of performing an action appropriate for a new domain by combining the inferred semantic skill sequence and inferred dynamics based on currently acquired environmental data (S300).

FIG. 4 is a block diagram illustrating a computing device for the one-shot imitation and learning method described above, and is a reconstruction of the aforementioned series of configurations from the perspective of hardware configuration. Accordingly, the function and operation of each component will be briefly described to avoid redundant description.

A computing device 800 includes a memory 830 that stores an artificial neural network model 831 that learns and adaptively executes one-shot imitation according to the aforementioned configuration, and a processor that controls the artificial neural network model to learn and execute one-shot imitation (810).

In the training stage, the artificial neural network model 831: learns to infer a semantic skill sequence from a given expert demonstration; learns to infer dynamics based on state-action pairs, which are the minimum units that form an action trajectory of the expert in the given expert demonstration; and learns to create an action sequence by combining the inferred semantic skill and dynamics based on given environmental data.

In the execution stage, the artificial neural network model 831 infers the semantic skill sequence from the given expert demonstration, operates an agent to generate the state-action pairs in time series, infers the dynamics of a current state based thereon, and reassembles the inferred semantic skills by combining the inferred semantic skill sequence and inferred dynamics based on the currently acquired environmental data.

The exemplary embodiments may also be embodied as computer-readable codes on a computer-readable recording medium. The computer-readable recording medium is any data storage device that may store data which can be thereafter read by a computer system.

Examples of the computer-readable recording medium include ROM, RAM, CD-ROMs, magnetic tapes, floppy disks, and optical data storage devices. In addition, the computer-readable recording medium may also be distributed over network coupled computer systems so that the computer-readable code is stored and executed in a distributed fashion. In addition, functional programs, codes, and code segments for implementing the exemplary embodiments may be easily construed by programmers of ordinary skill in the art to which the exemplary embodiments pertain.

While the present disclosure has been particularly shown and described, it will be understood by one of ordinary skill in the art that various changes in form and details may be made therein without departing from the spirit and scope of the present disclosure as defined by the appended claims. The scope of the present disclosure should be considered in a descriptive sense only and not for purposes of limitation. Therefore, the scope of the present disclosure is defined not by the detailed description of the present disclosure but by the appended claims, and all differences within the scope will be construed as being included in the present disclosure.

What is claimed is:

1. A learning method of a one-shot imitation method based on an artificial neural network model that adaptively one-shot imitates a video demonstration of an expert, the method comprising:
a first stage of learning to infer a semantic skill sequence from a given expert demonstration;
a second stage of learning to infer dynamics based on state-action pairs, which are the minimum units that form an action trajectory of the expert in the given expert demonstration; and
a third stage of learning to create an action sequence by combining the inferred semantic skill sequence and dynamics based on given environmental data.

2. The method of claim 1, wherein the artificial neural network model is based on a trained vision-language model configured of a vision encoder and a language encoder.

3. The method of claim 2, wherein the artificial neural network model is trained based on a prompt.

4. The method of claim 1, wherein, in order to infer parameters about an environment from the state-action pairs, the first stage is trained based on contrastive learning, in which the state-action pairs executed in the same environment are embedded in the same place, and the state-action pairs executed in different environments are embedded far apart from each other.

5. The method of claim 1, wherein the artificial neural network model comprises:
a contrastively trained semantic skill encoder (Φ_{enc}) that converts the video demonstration of the expert into the semantic skill sequence; and
a semantic skill decoder (Φ_{dec}) that infers the optimal skill from the semantic skill sequence depending on a state.

6. The method of claim 5, wherein the artificial neural network model further comprises:
skill transfer (πₜᵣ) that infers an action sequence optimized for an operation (execution) of an agent from a given semantic skill sequence and inferred dynamics; and
a dynamics encoder (ψ_{enc}) that infers the dynamics from expert trajectories.

7. A one-shot imitation method based on an artificial neural network model that adaptively one-shot imitates a video demonstration of an expert, the method comprising:
a first stage of inferring a semantic skill sequence from a given expert demonstration;
a second stage of operating an agent to generate state-action pairs in time series and inferring the dynamics of a current state based thereon; and
a third stage of performing an action appropriate for a new domain by combining the inferred semantic skill sequence and inferred dynamics based on currently acquired environmental data and recombining the inferred semantic skill sequence.

8. The method of claim 7, wherein the artificial neural network model is based on a trained vision-language model configured of a vision encoder and a language encoder.

9. The method of claim 7, wherein the artificial neural network model is trained based on a prompt.

10. The method of claim 7, wherein, in order to infer parameters about an environment from the state-action pairs, the first stage is trained based on contrastive learning, in which the state-action pairs executed in the same environment are embedded in the same place, and the state-action pairs executed in different environments are embedded far apart from each other.

11. The method of claim 7, wherein the artificial neural network model comprises:
a contrastively trained semantic skill encoder (Φ_{enc}) that converts the video demonstration of the expert into the semantic skill sequence; and
a semantic skill decoder (Φ_{dec}) that infers the optimal skill from the semantic skill sequence depending on a state.

12. The method of claim 11, wherein the artificial neural network model further comprises:
skill transfer (πₜᵣ) that infers an action sequence optimized for an operation (execution) of an agent from a given semantic skill sequence and inferred dynamics; and
a dynamics encoder (ψ_{enc}) that infers the dynamics from expert trajectories.

13. A computing device, comprising:
a memory that stores an artificial neural network model that adaptively one-shot imitates a video demonstration of an expert; and
a processor that executes the artificial neural network model,
wherein in a learning phase, the artificial neural network model: learns to infer a semantic skill sequence from a given expert demonstration; learns to infer dynamics based on state-action pairs, which are the minimum units that form an action trajectory of the expert in the given expert demonstration; and learns to create an action sequence by combining the inferred semantic skill sequence and dynamics based on given environmental data.

14. The computing device of claim 13, wherein, in an execution phase, the artificial neural network model: infers the semantic skill sequence from the given expert demonstration; operates an agent to generate the state-action pairs in time series to infer the dynamics of a current state; and performs an action appropriate for a new domain by combining the inferred semantic skill sequence and inferred dynamics based on currently acquired environmental data and reassembling the inferred semantic skill sequence.

15. The computing device of claim 13, wherein the artificial neural network model is based on a trained vision-language model configured of a vision encoder and a language encoder.

16. The computing device of claim 15, wherein the artificial neural network model is trained based on a prompt.

17. The computing device of claim 13, wherein the artificial neural network model is trained based on contrastive learning, in which the state-action pairs executed in the same environment are embedded in the same place, and the state-action pairs executed in different environments are embedded far apart from each other.

18. The computing device of claim 13, wherein the artificial neural network model comprises:
a contrastively trained semantic skill encoder (Φ_{enc}) that converts the video demonstration of the expert into the semantic skill sequence; and
a semantic skill decoder (Φ_{dec}) that infers the optimal skill from the semantic skill sequence depending on a state.

19. The computing device of claim 18, wherein the artificial neural network model further comprises:
skill transfer (πₜᵣ) that infers an action sequence optimized for an operation (execution) of an agent from a given semantic skill sequence and inferred dynamics; and
a dynamics encoder (ψ_{enc}) that infers the dynamics from expert trajectories.

20. A non-transitory computer-readable storage medium storing instructions that, when executed by a processor, configure the processor to perform the method of claim 1.
